(19) United States
(12) Patent Application Publication
(10) Pub. No.: US 2009/0141383 A1
(43) Pub. Date: Jun. 4, 2009

(54) SETTING METHOD OF MAGNETIC DISK APPARATUS AND MAGNETIC DISK SETTING APPARATUS

(75) Inventor: Yukio URATA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/325,190

(22) Filed: Nov. 29, 2008

(30) Foreign Application Priority Data
Nov. 30, 2007 (JP) 2007-310744

(51) Int. Cl. G11B 5/02

(52) U.S. Cl. 360/27; G9B/5.002

(57) ABSTRACT

A gain setting apparatus that externally performs setting of a magnetic disk apparatus before shipment causes a servo data gain setting unit to set a servo data gain for a preamplifier. The gain setting apparatus then causes a core deviation correction processor to set the servo data gain as a provisional user data gain, so as to perform core deviation correction for correcting positional misalignment between a read core and a write core. Further, the gain setting apparatus causes a user data gain setting unit to set the user data gain for the preamplifier.

### BACKGROUND OF THE INVENTION

1. Field of the Invention

The present invention relates to a setting method performed on a magnetic disk apparatus before shipment and to a magnetic disk setting apparatus. The magnetic disk apparatus is used by a user as an auxiliary storage device of a computer. The magnetic disk setting apparatus performs a setting operation on the magnetic disk apparatus.

2. Description of the Related Art

A magnetic disk apparatus is used as one of auxiliary storage apparatuses of a computer. The magnetic disk apparatus includes a disk with a magnetic material applied, and stores therein data by magnetizing the disk.

The magnetic disk apparatus stores therein data that is broadly classified into two types: one is called servo data, and the other user data. The servo data is written in advance for a head position control performed by the magnetic disk apparatus. On the other hand, the user data is written to the disk by the magnetic disk apparatus upon receiving a write command from the computer. Related art is disclosed in, for example, Japanese Patent Application Laid-open No. 2005-302295.

To read out such data from the disk, the magnetic disk apparatus causes a reproducing head to generate a signal from a magnetic field generated on the disk. Since the generated signal is small, the magnetic disk apparatus inputs the signal to a preamplifier so as to amplify the input signal.

In general, the gain is set commonly, not individually, for a servo data signal and a user data signal. That is to say, the preamplifier amplifies signals of the two types with a commonly set gain. For example, the preamplifier amplifies an input signal corresponding to the servo data signal and amplifies an input signal corresponding to the user data signal, similarly by 10 times.

In recent years, recording density of user data in magnetic disk apparatuses has been increasing. In a horizontal recording system, interval of magnetic poles on a disk becomes narrower as the recording density increases. Similarly, in a vertical recording system, areas of the poles on the disk become smaller as the recording density increases. Accordingly, the strength of the magnetic field generated by the magnetic poles becomes weak, so that the user data signal generated by the reproducing head becomes much smaller.

On the contrary, the recording density of the servo data remains still almost the same as it was before because information necessary for the magnetic disk apparatus to control the head position has not been remarkably changed. Thus, there is no need to make the magnetic poles to have a narrower interval or to make the poles to have smaller areas to increase the recording density of the servo data. Accordingly, the magnetic field generated by the magnetic poles has the same strength as it was before. As a result, the difference in voltage has been increased between the user data signal and the servo data signal.

In view of the foregoing, if the preamplifier amplifies the servo data signal and the user data signal with a commonly set gain as it was before, the user data signal cannot be processed in some circumstances. Hence, it causes a problem such that the magnetic disk apparatus cannot read out the user data.

Thus, there is a need for magnetic disk apparatuses to have an amplifier that amplifies an output signal from the head with a switchable gain depending on the type of the output signal, and to set an appropriate value for the gain of the preamplifier.

### SUMMARY

It is an object of the present invention to at least partially solve the problems in the conventional technology.

According to one aspect of the present invention, a setting method of a magnetic disk apparatus that has a preamplifier amplifying servo data for positioning-use with a servo data gain and amplifying user data stored in a user area available for reading and writing of given data with a user data gain, includes setting the servo data gain, setting a provisional user data gain as the servo data gain, finding a core deviation correction value for correcting positional misalignment between a read core and a write core by using the provisional user data gain, and setting the user data gain.

According to still another aspect of the present invention, a magnetic disk setting apparatus that performs an operational setting of a magnetic disk apparatus includes a preamplifier that amplifies servo data for positioning-use with a servo data gain and amplifies user data stored in a user area available for reading and writing of given data with a user data gain, a servo data gain setting unit that sets the servo data gain, a provisional user data gain setting unit that sets a provisional user data gain as the servo data gain, a core deviation correction unit that finds a core deviation correction value for correcting positional misalignment between a read core and a write core by using the provisional user data gain, and a user data gain setting unit that sets the user data gain.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a gain setting apparatus and a magnetic disk apparatus according to a first embodiment of the present invention;

FIG. 2 is a table of exemplary information stored in a setting information storage unit;

FIG. 3 is a flowchart of a processing operation performed by a gain controller of FIG. 1;

FIGS. 4A and 4B are schematic diagrams of gain setting;

FIG. 5 is a table of exemplary information stored in a gain setting table of FIG. 1;

FIG. 6 is a flowchart of a process flow performed by a main controller according to the first embodiment of the present invention;

FIG. 7 is a flowchart of a processing operation performed by a servo data gain setting unit of FIG. 1;

FIG. 8 is a flowchart of a processing operation performed by a core deviation correction processor of FIG. 1;

FIG. 9 is a flowchart of a processing operation performed by a user data gain setting unit of FIG. 1;

FIG. 10 is a flowchart for determining a user data gain based on a Viterbi margin;

FIG. 11 is a flowchart for determining a user data gain based on an error rate;

FIG. 12 is a schematic diagram of a gain setting apparatus and a magnetic disk apparatus according to a second embodiment of the present invention; and

FIG. 13 is a flowchart of a process flow performed by the main controller of FIG. 12.

### DETAILED DESCRIPTION OF THE PREFERRED EMBODIMENTS

Exemplary embodiments of a gain setting apparatus and a magnetic disk apparatus according to the present invention are described in detail with reference to the accompanying drawings.

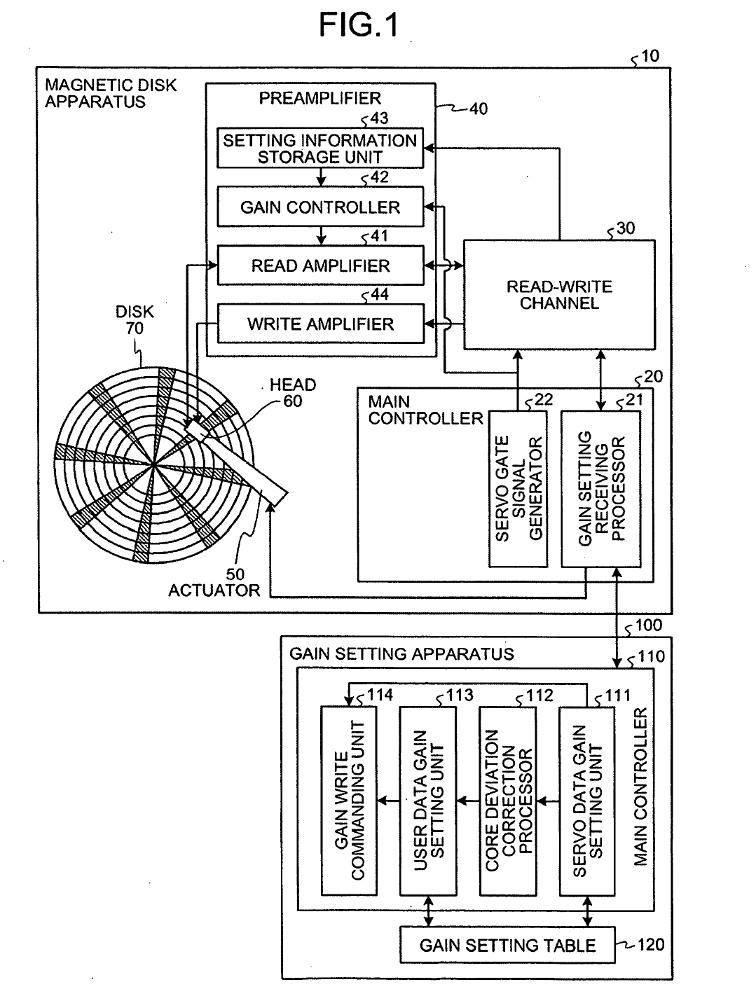

FIG. 1 is a schematic diagram for explaining a gain setting apparatus and a magnetic disk apparatus according to a first embodiment of the present invention. As shown in FIG. 1, a magnetic disk apparatus 10 includes a main controller 20, a read-write channel 30, a preamplifier 40, an actuator 50, a head 60, and a disk 70. A gain setting apparatus 100 includes a main controller 110 and a gain setting table 120.

The magnetic disk apparatus 10 is connected to a host computer (not shown) to serve as an auxiliary storage device of the host computer. The gain setting apparatus 100 is, for example, connected to the magnetic disk apparatus 10 in a communicable manner and adjusts the gain of the preamplifier 40 during manufacturing of the magnetic disk apparatus 10 before shipment as a product.

The following describes each element of the magnetic disk apparatus 10 serving as an auxiliary storage device.

The main controller 20 receives a data write command or a data read command from the host computer. According to the received command, the main controller 20 controls the actuator 50 to move the head 60 to a predetermined position on the disk 70. The main controller 20 then stores data in the disk 70 or reproduces data from the disk 70.

When the main controller 20 receives a data write command, the read-write channel 30 receives from the main controller 20 data to be stored in the disk 70. The read-write channel 30 then performs signal processes on the data, and outputs the processed data to the preamplifier 40.

On the contrary, when the main controller 20 receives a data read command, the read-write channel 30 receives from the preamplifier 40 data reproduced from the disk 70. The read-write channel 30 then performs signal processes on the data, and outputs the processed data to the main controller 20.

The preamplifier 40 amplifies an output from the read-write channel 30, and inputs the amplified output to the head 60. As a result, data is stored in the disk 70.

On the contrary, when data is reproduced from the disk 70, the preamplifier 40 amplifies an output from the head 60, and inputs the amplified output to the read-write channel 30.

The preamplifier 40 amplifies an output signal from the head 60 with a switchable gain depending on the type of the output signal. The following describes specific operations performed by the preamplifier 40. The operations performed by the preamplifier 40 are related to a servo gate signal, so the servo gate signal is described first.

As shown in FIG. 1, the disk 70 is divided into a plurality of ring-shaped areas, each of which is called a track. In the disk 70, each of the tracks is further divided into predetermined areas, to which servo data and user data are written as magnetic information.

Specifically, in the disk 70, the servo data is written to areas indicated by hatched lines, and the user data is written to the other areas, as magnetic information. The servo data is magnetic information to be written to the disk 70 in advance to control the position of the head 60 by the magnetic disk apparatus 10. On the other hand, the user data is magnetic information that the main controller 20 writes to the disk 70 in response to a write command received from the host computer 200.

The disk 70 is rotated at a predetermined rotational frequency during an operation of the magnetic disk apparatus 10.

The head 60 is lifted up from a surface of the disk 70 with a certain space in between, and reads out magnetic information from the surface of the disk 70.

Due to the rotation of the disk 70, the head 60 alternately faces servo areas to which the magnetic information corresponding to the servo data is written and data areas to which the magnetic information corresponding to the user data is written.

Accordingly, the head 60 generates a servo data signal and a user data signal based on the magnetic information written to the respective areas, and outputs the signals to the preamplifier 40.

The preamplifier 40 amplifies each of the output signals from the head 60 with a predetermined gain, and outputs the signal to the read-write channel 30.

As described above, either the servo data signal or the user data signal is constantly input to the read-write channel 30 during operation of the magnetic disk apparatus 10.

In response to a command from the main controller 20, the read-write channel 30 performs various signal processes on the input signal from the preamplifier 40, and outputs the processed signal to the main controller 20.

When performing such signal processes, the read-write channel 30 needs to identify whether the signal received from the preamplifier 40 is a servo data signal or a user data signal, so as to only process the servo data signal and output the processing result to the main controller 20 or to only process the user data signal and output the processing result to the main controller 20.

The servo gate signal is a signal that indicates whether the magnetic information read out by the head 60 is the servo data for positioning-use or the user data stored in a user area available for reading and writing of given data. The servo gate signal is generated at a servo gate signal generator 23 in the main controller 20, and the servo gate signal is input to the read-write channel.

Based on the servo gate signal, the read-write channel 30 processes an input signal from the preamplifier 40 individually, depending on whether the signal is the servo data signal or the user data signal.

The servo gate signal may be, for example, a signal having an output level that alternately changes between a first predetermined value and a second predetermined value at certain intervals. In this case, the read-write channel 30 determines a signal received from the preamplifier 40 to be the servo data signal when receiving a servo gate signal at the first predetermined value. On the contrary, if the output level is changed and the servo gate signal is received at the second predetermined value, the read-write channel 30 determines a signal received from the preamplifier 40 to be the user data signal.

Hereinbefore, the servo gate signal is explained. In the magnetic disk apparatus 10, the servo gate signal is input to the preamplifier 40, as well as to the read-write channel 30.

The preamplifier 40 includes a setting information storage unit 43, a gain controller 42, a read amplifier 41, and a write amplifier 44. The servo gate signal is input to the gain controller 42.

The read amplifier 41 amplifies an output from the head 60 with a predetermined gain. The read amplifier 41 uses a variable gain that is controlled by a gain controller 42 described later.

The write amplifier 44 amplifies an output from the read-write channel 30 with a predetermined gain, and outputs the amplified output to the head 60.

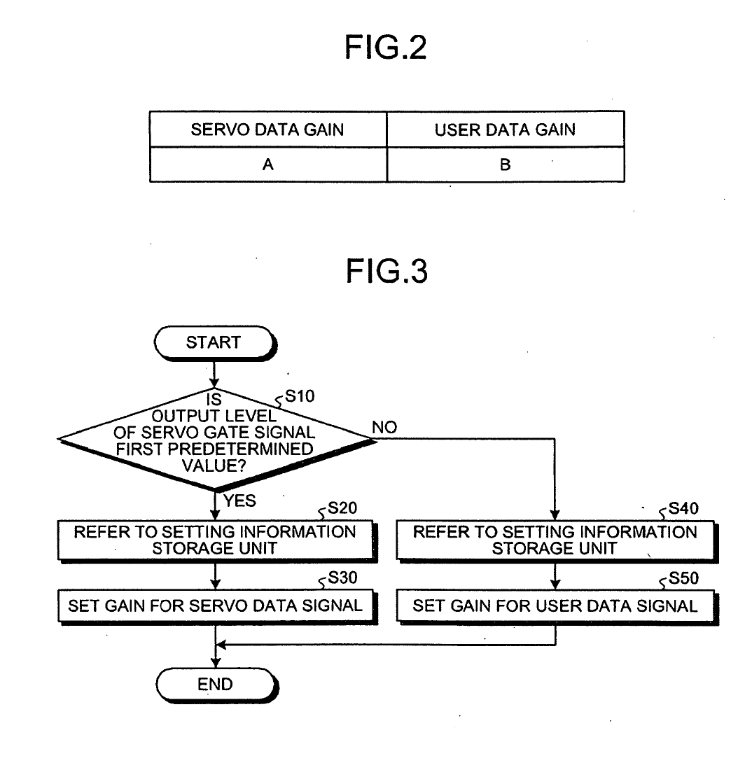

The setting information storage unit 43 stores therein a first gain for the servo data signal (a servo data gain) and a second gain for the user data signal (a user data gain). For example, as shown in FIG. 2, the setting information storage unit 43 stores therein a gain “A” for the servo data signal and a gain “B” for the user data signal. FIG. 2 is a table of exemplary information stored in the setting information storage unit 43.

The gain controller 42 changes the gain of the read amplifier 41 based on the servo gate signal, depending on whether the magnetic information is the servo data or the user data.

Processing operations of the gain controller 42 of when, for example, output level of the servo gate signal alternately changes between the first predetermined value and the second predetermined value at certain intervals, are explained with reference to a flowchart shown in FIG. 3.

FIG. 3 is a flowchart of a processing operation performed by the gain controller 42. The process flow shown in FIG. 3 is repeatedly performed during operation performed by the magnetic disk apparatus 10.

If an output level of the received servo gate signal is the first predetermined value (YES at Step S10), the gain controller 42 determines that a signal being received from the head 60 is the servo data signal. The gain controller 42 then refers to the setting information storage unit 43 (Step S20), and sets the gain of the read amplifier 41 to the gain “A” for the servo data signal (Step S30).

On the contrary, if the output level of the received servo gate signal is the second predetermined value (NO at Step S10), the gain controller 42 determines that a signal being received from the head 60 is the user data signal. The gain controller 42 then refers to the setting information storage unit 43 (Step S40), and sets the gain of the read amplifier 41 to the gain “B” for the user data signal (Step S50).

Hereinbefore, the operations of the preamplifier 40 are explained. As described above, the preamplifier 40 of the magnetic disk apparatus 10 amplifies an output signal from the head 60 with a switchable gain depending on the type of the output signal.

The gain setting apparatus 100 is now described. The gain setting apparatus 100 sets an appropriate gain for the preamplifier 40 of the magnetic disk apparatus 10. The appropriate gain is described as below.

The preamplifier 40 amplifies an output from the head 60, and inputs the amplified output to the read-write channel 30, as described above.

The output voltage of the head 60 is not constant and may vary, so that the voltage of a signal amplified by the preamplifier 40 may also vary. Thus, the read-write channel 30 includes an automatic gain control (AGC) amplifier circuit.

With the AGC amplifier circuit further amplifying an input signal received from the preamplifier 40, the read-write channel 30 decreases the voltage of the input signal if the input signal is high and increases the voltage if the input signal is low. In this way, the read-write channel 30 maintains the voltage to be constant, and performs the subsequent signal processes.

However, the AGC amplifier circuit has limited control, and if the voltage of the input signal is too high or too low, the read-write channel 30 cannot maintain the voltage of the signal to be constant and also the signal processes cannot be performed. As a result, data readout error occurs in the magnetic disk apparatus 10.

Thus, it is desirable to set a gain for the preamplifier 40 such that the voltage of the input signal becomes not too high or not too low even when the output voltage of the head 60 varies. Such gain is the appropriate gain. It is possible to set the gain for the servo data signal and the gain for the user data signal individually for the preamplifier 40.

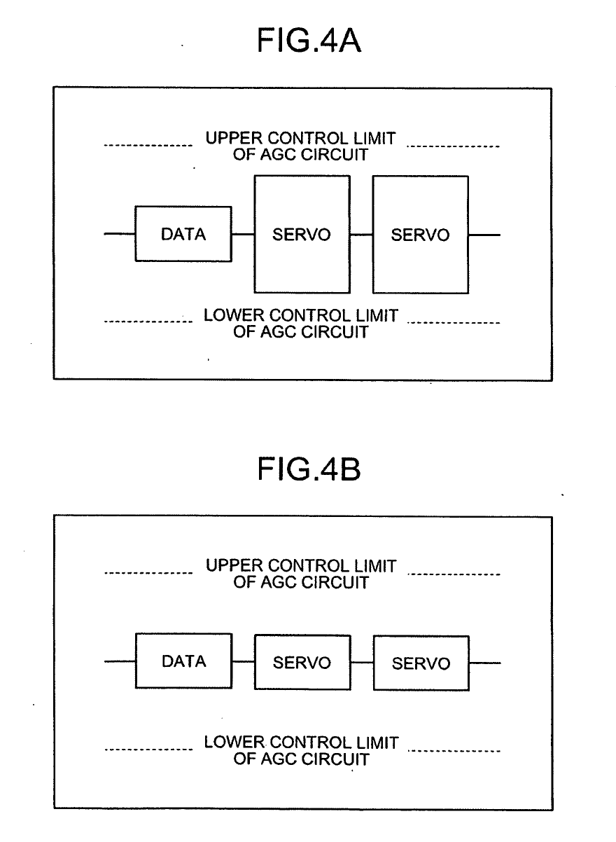

Conventionally, as shown in FIG. 4A, the amplified voltage of the servo data and the amplified voltage of the user data vary because the servo data and the user data are amplified with a commonly set gain. Hence, the gain setting apparatus 100 corrects such variation. Specifically, as shown in FIG. 4B, it is desirable that the gain setting apparatus 100 equalize output voltages of the servo data and of the user data, and set the amplified voltages thereof to fall in a range controllable by the AGC amplifier circuit even when the amplified voltages vary in plus and minus to some extent.

The explanation now returns to that of the gain setting apparatus 100. The gain setting apparatus 100 includes the main controller 110 and the gain setting table 120.

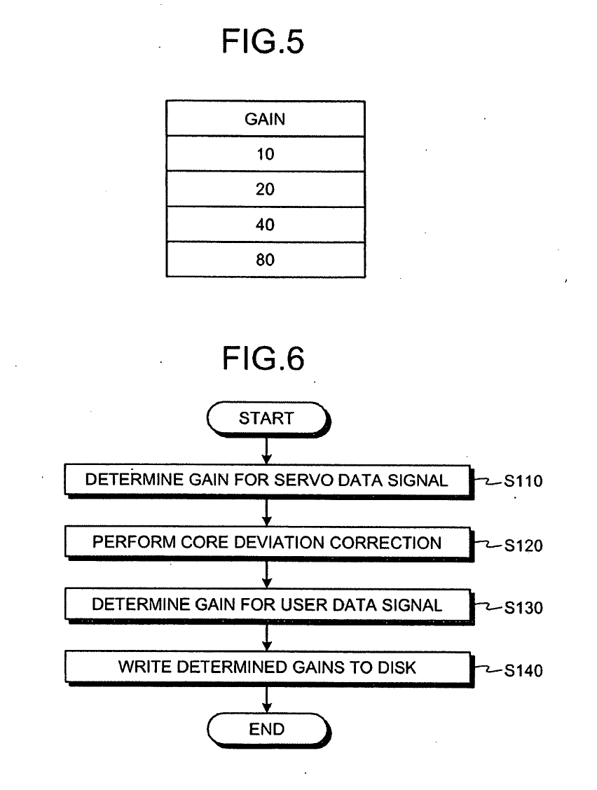

The gain setting table 120 stores therein a plurality of gains. As shown in FIG. 5, the gain setting table 120 stores therein, for example, four gains: “10,” “20,” “40,” and “80.” FIG. 5 is a table of exemplary information stored in the gain setting table 120.

The main controller 110 communicates with a gain setting receiving processor 21 of the magnetic disk apparatus 10. The main controller 110 includes a servo data gain setting unit 111, a core deviation correction processor 112, a user data gain setting unit 113, and a gain write commanding unit 114. Each of the elements is described with reference to FIGS. 6 to 9 below.

FIG. 6 is a flowchart of a process flow performed by the main controller 110. The process flow shown in FIG. 6 is performed when the gain setting apparatus 100 is powered on.

The main controller 110 causes the servo data gain setting unit 111 to determine a gain for the servo data signal (Step S110).

The main controller 110 then causes the core deviation correction processor 112 to perform core deviation correction (Step S120).

Further, the main controller 110 causes the user data gain setting unit 113 to determine a gain for the user data signal (Step S130).

Finally, the main controller 110 causes the gain write commanding unit 114 to write the determined gains to the disk (Step S140).

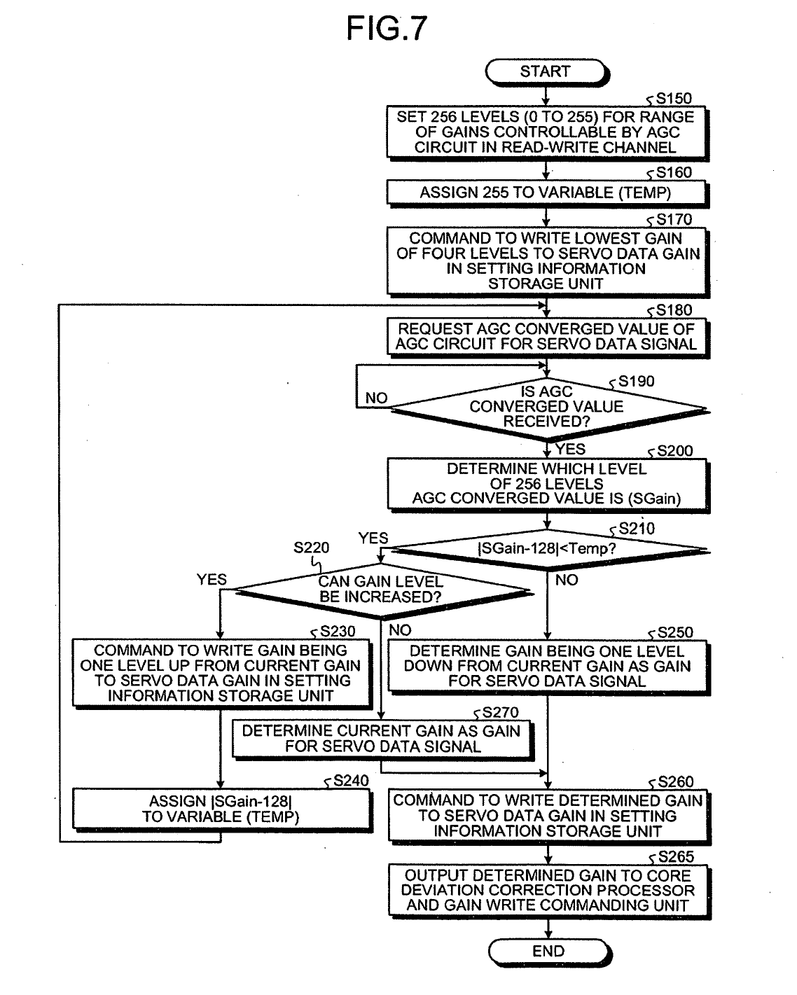

The overall process flow performed by the main controller 110 is explained above. The following describes a specific process performed by the servo data gain setting unit 111, with reference to FIG. 7. FIG. 7 is a flowchart of a processing operation performed by the servo data gain setting unit 111. The process flow shown in FIG. 7 is performed when the gain setting apparatus 100 is powered on.

The servo data gain setting unit 111 sets 256 levels (0 to 255) for the range of gains controllable by the AGC amplifier circuit in the read-write channel 30 (Step S150). The servo data gain setting unit 111 then assigns 255 to a variable (Temp) (Step S160).

After the aforementioned initial setting, the servo data gain setting unit 111 commands the gain setting receiving processor 21 to write the lowest gain “10” of the four gain levels stored in the gain setting table 120 (see FIG. 5) to the servo data gain in the setting information storage unit 43 (Step S170).

Receiving the command, the gain setting receiving processor 21 writes the specified gain to the servo data gain in the setting information storage unit 43, and sends a response to the servo data gain setting unit 111.

Receiving the response from the gain setting receiving processor 21, the servo data gain setting unit 111 requests an AGC converged value of the AGC amplifier circuit for the servo data signal (Step S180). The AGC converged value is a gain when the read-write channel 30 further amplifies an input signal in the AGC amplifier circuit and maintains the voltage of the input signal to be constant.

In response to the request, the gain setting receiving processor 21 measures the AGC converged value of the AGC amplifier circuit by reading out the servo data from the disk 70, and then sends the AGC converged value to the servo data gain setting unit 111.

Receiving the AGC converged value from the gain setting receiving processor 21 (YES at Step S190), the servo data gain setting unit 111 determines which level of the 256 levels the AGC converged value is (SGain) (Step S200).

The servo data gain setting unit 111 then obtains the absolute value of the SGain relative to an origin 128, and compares it with the variable Temp (Step S210). The origin 128 is a value indicating a medium of the 256 levels determined in the initial setting.

If the absolute value of the SGain relative to the origin 128 is smaller than the variable Temp (YES at Step S210), the servo data gain setting unit 111 determines whether the gain level to be written to the servo data gain in the setting information storage unit 43 can be further increased (Step S220).

The current gain is the lowest gain “10” and the level can be increased (YES at Step S220). Therefore, the servo data gain setting unit 111 commands the gain setting receiving processor 21 to write the gain “20,” which is one level up from the current gain (see FIG. 5), to the servo data gain in the setting information storage unit 43 (Step S230). Further, the servo data gain setting unit 111 assigns the absolute value of the obtained SGain relative to the origin 128 to the variable (Temp) (Step S240), so that the absolute value of the currently obtained SGain relative to the origin 128 and the absolute value of the previously obtained SGain relative to the origin 128 can be compared at Step S210.

Receiving the command, the gain setting receiving processor 21 similarly writes the specified gain to the servo data gain in the setting information storage unit 43, and sends a response to the servo data gain setting unit 111.

Receiving the response from the gain setting receiving processor 21, the servo data gain setting unit 111 returns to Step S180, and again requests the AGC converged value of the AGC amplifier circuit for the servo data signal (Step S180).

Steps S180 to S240 are repeated, and if the absolute value of the currently obtained SGain relative to the origin 128 exceeds the absolute value of the previously obtained SGain relative to the origin 128 (NO at Step S210), the servo data gain setting unit 111 determines that a gain being one level down from the current gain is the gain for the servo data signal (Step S250).

On the contrary, Steps S180 to S240 are repeated, and if the gain level to be written to the servo data gain in the setting information storage unit 43 cannot be increased (NO at Step S220), the servo data gain setting unit 111 determines that the current gain is the gain for the servo data signal (Step S270).

After determining the gain for the servo data signal (Step S250 or Step S270), the servo data gain setting unit 111 commands the gain setting receiving processor 21 to write the determined gain to the servo data gain in the setting information storage unit 43 (Step S260).

Receiving the response from the gain setting receiving processor 21, the servo data gain setting unit 111 outputs the determined gain to the core deviation correction processor 112 and the gain write commanding unit 114 (Step S265), and terminates the process.

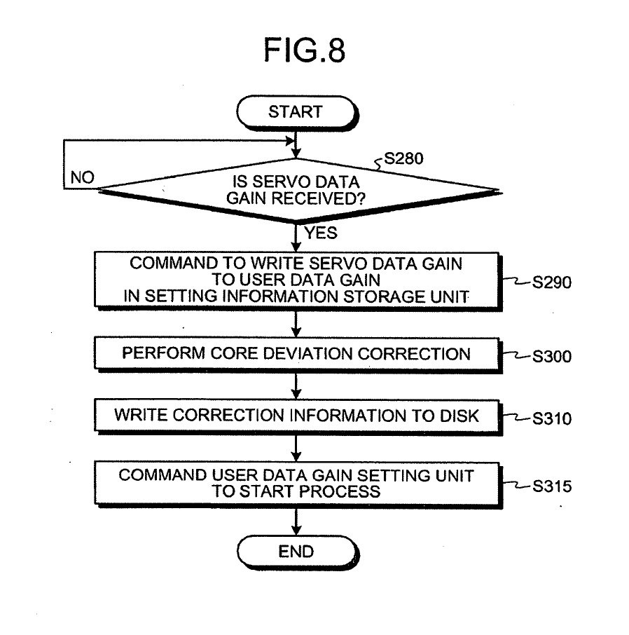

Referring to FIG. 8, the following describes a specific process performed by the core deviation correction processor 112. FIG. 8 is a flowchart of a processing operation performed by the core deviation correction processor 112. The process flow shown in FIG. 8 is performed when the gain setting apparatus 100 is powered on.

The core deviation correction processor 112 waits for an output from the servo data gain setting unit 111. When receiving a gain (YES at Step S280), the core deviation correction processor 112 commands the gain setting receiving processor 21 to write the gain to the user data gain in the setting information storage unit 43 (Step S290).

Receiving the command, the gain setting receiving processor 21 writes the specified gain to the user data gain in the setting information storage unit 43, and sends a response to the core deviation correction processor 112.

Receiving the response from the gain setting receiving processor 21, the core deviation correction processor 112 accesses the magnetic disk apparatus 10 through the gain setting receiving processor 21, and performs the core deviation correction (Step S300).

Now, the core deviation correction is described. The head 60 includes a write head core for writing data to the disk 70 and a read head core for reading out data from the disk 70. The write head core and the read head core are attached to different positions on the head 60.

After data is written with the head 60 positioned on a given track, even by positioning the head 60 to read out the data to the same position on the track as in writing, the read head core may be misaligned with the data write position.

Hence, to read out the data, the core deviation correction is performed for adjusting the read head core not to differ from the data write position.

After the core deviation correction, the core deviation correction processor 112 commands the gain setting receiving processor 21 to write correction information to the disk 70 (Step S310). Such correction information is read out from the disk 70 when the magnetic disk apparatus 10 after shipment is powered on. Based on the correction information, positioning of the head 60 is adjusted so that the read head core may not be misaligned with the data write position.

Receiving the command, the gain setting receiving processor 21 writes the correction information to the disk 70, and sends a response to the core deviation correction processor 112.

Receiving the response from the gain setting receiving processor 21, the core deviation correction processor 112 commands the user data gain setting unit 113 to start a process (Step S315), and terminates the process.

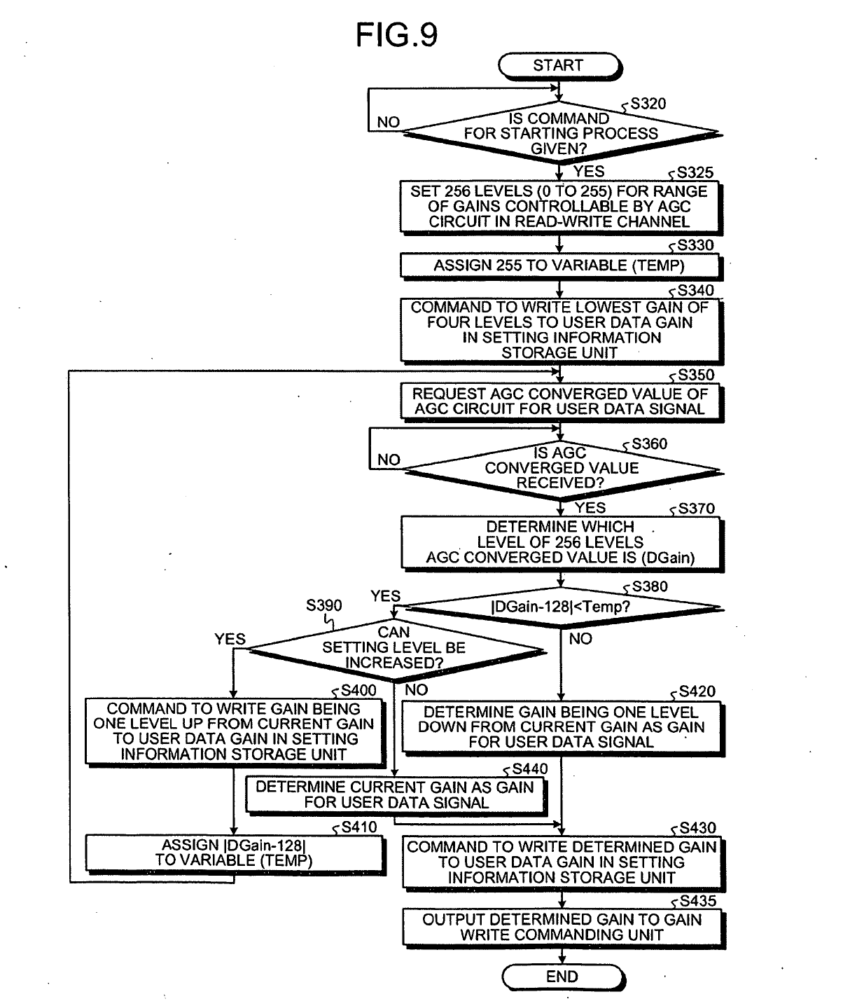

Referring to FIG. 9, the following describes a specific process performed by the user data gain setting unit 113. FIG. 9 is a flowchart of processing operations performed by the user data gain setting unit 113. The process flow shown in FIG. 9 is performed when the gain setting apparatus 100 is powered on.

When a command for starting a process is given from the core deviation correction processor 112 (YES at Step S320), the user data gain setting unit 113 sets 256 levels: 0 to 255 for the range of gains controllable by the AGC amplifier circuit in the read-write channel 30 (Step S325). The user data gain setting unit 113 then assigns 255 to a variable (Temp) (Step S330).

After the aforementioned initial setting, the user data gain setting unit 113 commands the gain setting receiving processor 21 to write the lowest gain “10” of the four gain levels stored in the gain setting table 120 (see FIG. 5) to the user data gain in the setting information storage unit 43 (Step S340).

Receiving the command, the gain setting receiving processor 21 writes the specified gain to the user data gain in the setting information storage unit 43, and sends a response to the user data gain setting unit 113.

Receiving the response from the gain setting receiving processor 21, the user data gain setting unit 113 requests an AGC converged value of the AGC amplifier circuit for the user data signal (Step S350).

In response to the request, the gain setting receiving processor 21 measures the AGC converged value of the AGC amplifier circuit by reading out the user data from the disk 70, and then sends the AGC converged value to the user data gain setting unit 113.

Receiving the AGC converged value from the gain setting receiving processor 21 (YES at Step S360), the user data gain setting unit 113 determines which level of the 256 levels the AGC converged value is (DGain) (Step S370).

The user data gain setting unit 113 then obtains the absolute value of the DGain relative to the origin 128, and compares it with the variable Temp (Step S380). The origin 128 is a value indicating the medium of the 256 levels determined in the initial setting.

If the absolute value of the DGain relative to the origin 128 is smaller than the variable Temp (YES at Step S380), the user data gain setting unit 113 determines whether the gain level to be written to the user data gain in the setting information storage unit 43 can be further increased (Step S390).

The current gain is the lowest gain “10” and the level can be increased (YES at Step S390). Therefore, the user data gain setting unit 113 commands the gain setting receiving processor 21 to write the gain “20” , which is one level up from the current gain (see FIG. 5), to the user data gain in the setting information storage unit 43 (Step S400). Further, the user data gain setting unit 113 assigns the absolute value of the obtained DGain relative to the origin 128 to the variable (Temp) (Step S410), so that the absolute value of the currently obtained DGain relative to the origin 128 and the absolute value of the previously obtained DGain relative to the origin 128 can be compared at Step S380.

Receiving the command, the gain setting receiving processor 21 similarly writes the specified gain to the user data gain in the setting information storage unit 43, and sends a response to the user data gain setting unit 113.

Receiving the response from the gain setting receiving processor 21, the user data gain setting unit 113 returns to Step S350, and again requests the AGC converged value of the AGC amplifier circuit for the user data signal (Step S350).

Steps S350 to S410 are repeated, and if the absolute value of the currently obtained DGain relative to the origin 128 exceeds the absolute value of the previously obtained DGain relative to the origin 128 (NO at Step S380), the user data gain setting unit 113 determines that a gain being one level down from the current gain is the gain for the user data signal (Step S420).

On the contrary, Steps S350 to S410 are repeated, and if the gain level to be written to the user data gain in the setting information storage unit 43 cannot be increased (NO at Step S390), the user data gain setting unit 113 determines that the current gain is the gain for the user data signal (Step S440).

After determining the gain for the user data signal (Step S420 or Step S440), the user data gain setting unit 113 commands the gain setting receiving processor 21 to write the determined gain to the user data gain in the setting information storage unit 43 (Step S430).

Receiving the response from the gain setting receiving processor 21, the user data gain setting unit 113 outputs the determined gain to the gain write commanding unit 114 (Step S435), and terminates the process.

While in the present embodiment, the user data gain setting unit 113 determines the user data gain based on the AGC converged value, the user data gain may be determined based on a Viterbi margin or an error rate. The Viterbi margin indicates how easy to read out the user data, and is measured in the read-write channel 30. The error rate indicates a probability of errors in reading out the user data.

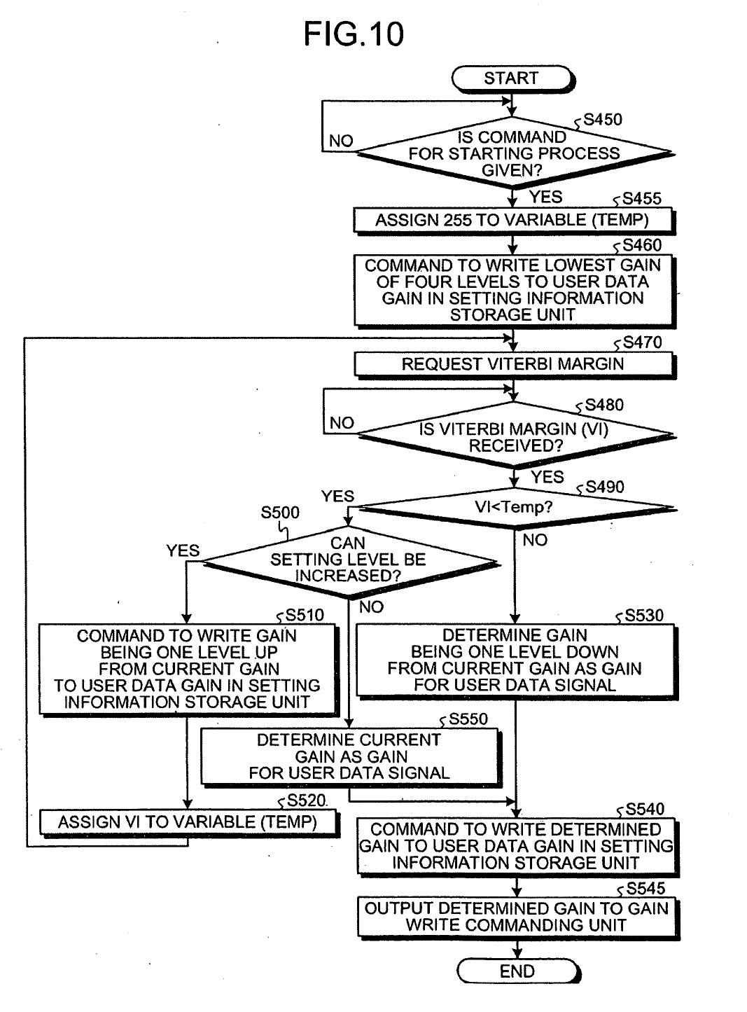

Referring to FIG. 10, the following describes a specific process performed by the user data gain setting unit 113 to determine the user data gain based on the Viterbi margin.

When a command for starting a process is given from the core deviation correction processor 112 (YES at Step S450), the user data gain setting unit 113 assigns 255 to a variable (Temp) (Step S455).

After the above initial setting, the user data gain setting unit 113 commands the gain setting receiving processor 21 to write the lowest gain “10” of the four gain levels stored in the gain setting table 120 (see FIG. 5) to the user data gain in the setting information storage unit 43 (Step S460).

Receiving the command, the gain setting receiving processor 21 writes the specified gain to the user data gain in the setting information storage unit 43, and sends a response to the user data gain setting unit 113.

Receiving the response from the gain setting receiving processor 21, the user data gain setting unit 113 requests a viterbi margin for the user data signal (Step S470).

In response to the request, the gain setting receiving processor 21 obtains a Viterbi margin (VI) measured in the read-write channel 30, and then sends it to the user data gain setting unit 113.

Receiving the Viterbi margin from the gain setting receiving processor 21 (YES at Step S480), the user data gain setting unit 113 compares the VI value with the variable Temp (Step S490).

If the VI value is smaller than the variable Temp (YES at Step S490), the user data gain setting unit 113 determines whether the gain level to be written to the user data gain in the setting information storage unit 43 can be further increased (Step S500).

The current gain is the lowest gain “10” and the level can be increased (YES at Step S500). Therefore, the user data gain setting unit 113 commands the gain setting receiving processor 21 to write the gain “20,” which is one level up from the current gain (see FIG. 5), to the user data gain in the setting information storage unit 43 (Step S510). Further, the user data gain setting unit 113 assigns the VI value to the variable (Temp) (Step S520), so that the currently obtained VI value and the previously obtained VI value can be compared at Step S490.

Receiving the command, the gain setting receiving processor 21 similarly writes the specified gain to the user data gain in the setting information storage unit 43, and sends a response to the user data gain setting unit 113.

Receiving the response from the gain setting receiving processor 21, the user data gain setting unit 113 returns to Step S470, and again requests the Viterbi margin for the user data signal (Step S470).

Steps S470 to S520 are repeated, and if the currently obtained VI value exceeds the previously obtained VI value (NO at Step S490), the user data gain setting unit 113 determines that a gain being one level down from the current gain is the gain for the user data signal (Step S530).

On the contrary, Steps S470 to S520 are repeated, and if the gain level to be written to the user data gain in the setting information storage unit 43 cannot be increased (NO at Step S500), the user data gain setting unit 113 determines that the current gain is the gain for the user data signal (Step S550).

After determining the gain for the user data signal (Step S530 or Step S550), the user data gain setting unit 113 commands the gain setting receiving processor 21 to write the determined gain to the user data gain in the setting information storage unit 43 (Step S540).

Receiving the response from the gain setting receiving processor 21, the user data gain setting unit 113 outputs the determined gain to the gain write commanding unit 114 (Step S545), and terminates the process.

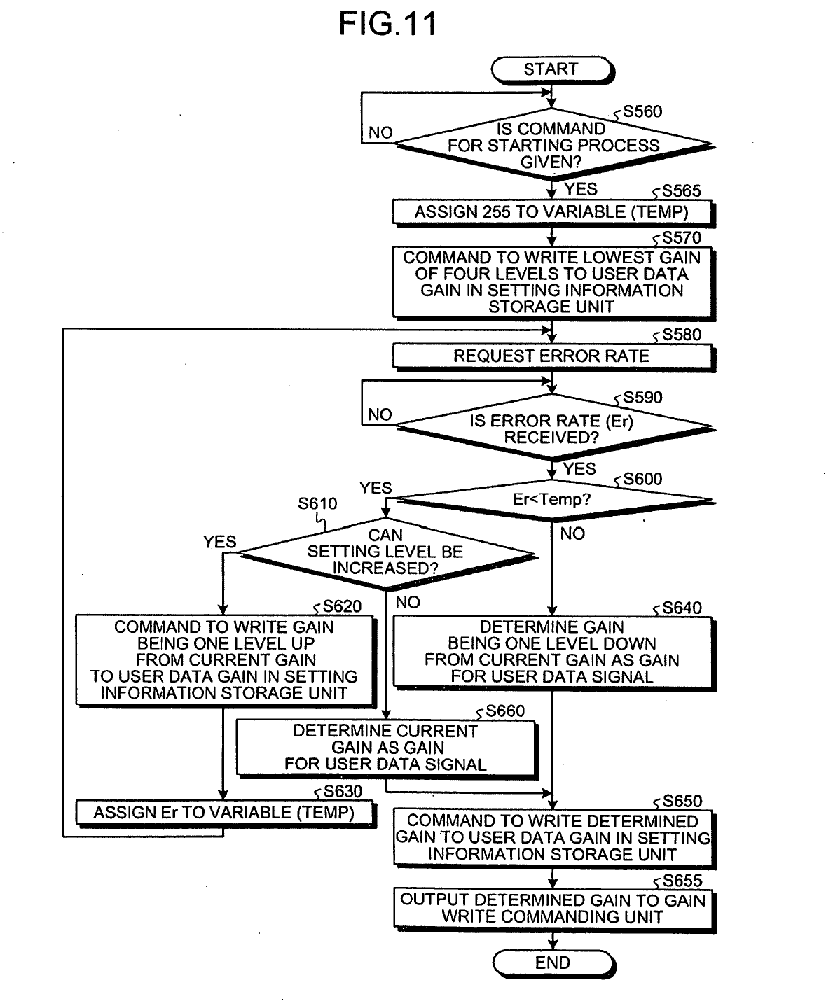

FIG. 11 is a flowchart of a process flow performed by the user data gain setting unit 113 to determine the user data gain based on the error rate. In the process flow, only the value requested to the gain setting receiving processor 21, i.e., the error rate, is altered from the viterbi margin, with other details being the same as those in FIG. 10, and thus the description thereof is omitted.

The process performed by the gain write commanding unit 114 is now described. Upon receiving the servo data gain and the user data gain respectively from the servo data gain setting unit 111 and the user data gain setting unit 113, the gain write commanding unit 114 commands the gain setting receiving processor 21 to write the two gains to the disk 70.

Such gains are read out from the disk 70 when the magnetic disk apparatus 10 after shipment is powered on, and stored in the setting information storage unit 43 of the preamplifier 40.

According to the first embodiment described above, it is possible to perform setting before shipment on the magnetic disk apparatus including the preamplifier that amplifies an output signal from the head with a switchable gain depending on the type of the output signal. Particularly, it is possible to set the servo data gain and the user data gain of the preamplifier.

Further, the servo data gain and the user data gain can be set based on the AGC converged value, the Viterbi margin, or the error rate.

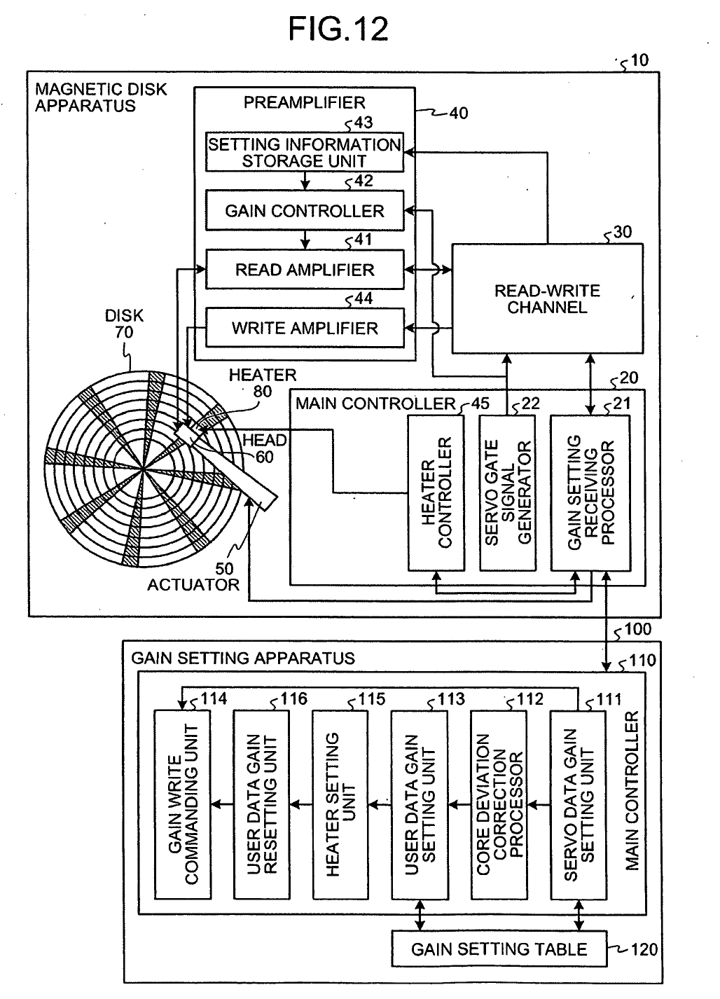

FIG. 12 is a schematic diagram of a gain setting apparatus and a magnetic disk apparatus according to a second embodiment of the present invention. The second embodiment differs from the first embodiment in that the magnetic disk apparatus 10 can adjust the lift amount of the head 60 with a heater controller 45 and a heater 80. The gain setting apparatus 100 not only sets an appropriate gain for the preamplifier 40, but also performs a predetermined setting in advance to enable functioning of the heater controller 45 and the heater 80.

The magnetic disk apparatus 10 includes the main controller 20, the read-write channel 30, the preamplifier 40, the actuator 50, the head 60, and the disk 70 as in the first embodiment, and further includes the heater 80. The main controller 20 includes the gain setting receiving processor 21 and the servo gate signal generator 22 as in the first embodiment, and further includes the heater controller 45.

The gain setting apparatus 100 includes the main controller 110 and the gain setting table 120. The main controller 110 includes the servo data gain setting unit 111, the core deviation correction processor 112, the user data gain setting unit 113, and the gain write commanding unit 114 as in the first embodiment, and further includes a heater setting unit 115 and a user data gain resetting unit 116.

The heater controller 45 adjusts the lift amount of the head 60 by changing electric power to be output to the heater 80 depending on the position of the head 60 on the disk 70 or the temperature in the magnetic disk apparatus 10.

The heater 80 has a temperature that varies depending on the electric power output from the heater controller 45, so as to transmit the heat to the head 60 or derive the heat from the head 60. As a result, the head 60 is thermally expanded to approach the surface of the disk 70, or is returned to its original shape to move away from the surface of the disk 70. Accordingly, the lift amount is adjusted.

To adjust the lift amount of the head 60 with the heater controller 45 and the heater 80, it is necessary to set in advance (hereinafter, “heater setting”) a location of the head 60 on the disk 70 or output power in watt as function of a temperature inside the magnetic disk apparatus 10. In the gain setting apparatus 100, the heater setting unit 115 performs the heater setting.

If the heater setting is performed after the determination of the gain for the user data signal, the output voltage of the head 60 varies upon reproduction of the user data, and therefore the gain for the user data signal needs to be determined again. Hence, the gain setting apparatus 100 includes the user data gain resetting unit 116 to redetermine the gain for the user data signal.

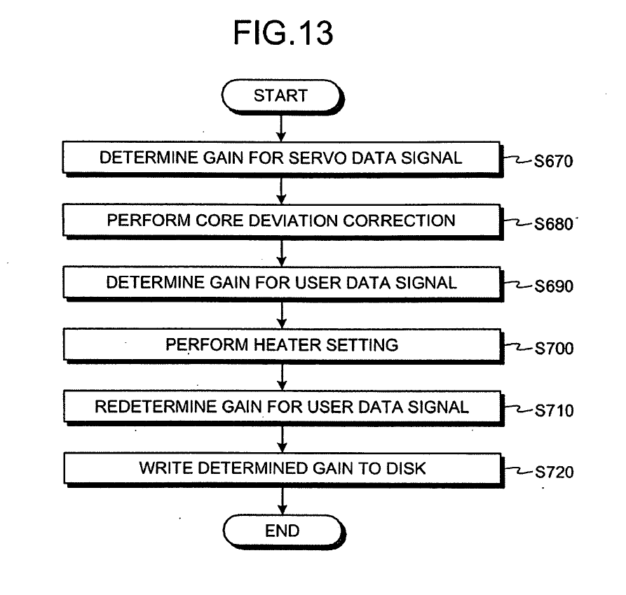

FIG. 13 is a flowchart of a flow process performed by the main controller 110 of the gain setting apparatus 100. The process flow shown in FIG. 13 is performed when the gain setting apparatus 100 is powered on.

The main controller 110 causes the servo data gain setting unit 111 to determine the gain for the servo data signal (Step S670).

The main controller 110 causes the core deviation correction processor 112 to perform the core deviation correction (Step S680).

The main controller 110 causes the user data gain setting unit 113 to determine the gain for the user data signal (Step S690). In the second embodiment, the user data gain setting unit 113 commands the heater setting unit 115 to perform the heater setting after the determination of the gain.

The main controller 110 then causes the heater setting unit 115 to perform the heater setting (Step S700).

Further, the main controller 110 causes the user data gain resetting unit 116 to redetermine the gain for the user data signal (Step S710). The redetermined gain for the user data signal is output to the gain write commanding unit 114.

Finally, the main controller 110 causes the gain write commanding unit 114 to write the determined gain to the disk (Step S720).

According to the second embodiment described above, after the determination of the servo data gain and the user data gain of the preamplifier, even when setting (e.g., the heater setting) is performed and causes variation in the output from the head, particularly in the output in reading out the user data, it is eventually possible to set the servo data gain and the user data gain of the preamplifier.

The second embodiment deals with the heater setting as an example of the setting performed on the magnetic disk apparatus 10, particularly the setting that causes, if performed after the determination of the gain for the user data signal, variation in the output voltage of the head 60 upon reproduction of the user data. Similarly, the setting of a write current also causes, if performed after the determination of the gain for the user data signal, variation in the output voltage of the head 60 upon reproduction of the user data. Thus, it is desirable to redetermine the gain for the user data signal.

In the first and the second embodiments, the gain setting apparatus 100 serving as an external device sets an appropriate gain for the preamplifier 40. The present invention is not limited to this, and may cause the main controller 20 (a micro controller unit (MCU) or a micro processing unit (MPU)) of the magnetic disk apparatus 10 to implement programs for performing the gain setting process described in the first or the second embodiment.

The foregoing describes some embodiments of the gain setting apparatus according to the present invention. Constituting elements shown in the drawings indicate ideational functions, and their physical arrangements are not necessarily the same as those shown in the drawings. Thus, the arrangement of distributing and integrating the devices is not limited to those specifically shown in the drawings, and all of or part of the devices may be modified concerning functional and physical aspects based on given units, with loads on and usage of the devices taken into account. For example, the core deviation correction processor 112 may be integrated with the user data gain setting unit 113. Further, as to the processing functions implemented in the devices, all of or any portion of the functions may be implemented by central processing units (CPUs) (or MCUs or MPUs) and programs interpretable and executable by the CPUs, or may be implemented in hardware using wired logic.

In addition, processing procedures, controlling procedures, specific names, information including various kinds of data and parameters shown in the description and the drawings may be changed in any way unless otherwise specified. For example, in the processing procedure shown in FIG. 7, the initial setting is performed in any sequence, and Step S150 and Step S160 may be interchanged with each other.

According to an embodiment of the present invention, a method disclosed herein enables setting on a magnetic disk apparatus before shipment that includes a preamplifier amplifying an output signal from a head with a switchable gain depending on the type of the output signal. Particularly, the method achieves such an advantage as setting a servo data gain and a user data gain individually for the gain of the preamplifier.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A setting method of a magnetic disk apparatus that has a preamplifier amplifying servo data for positioning-use with a servo data gain and amplifying user data stored in a user area available for reading and writing of given data with a user data gain, the setting method comprising:
setting the servo data gain;
setting a provisional user data gain as the servo data gain;
finding a core deviation correction value for correcting positional misalignment between a read core and a write core by using the provisional user data gain; and
setting the user data gain.

2. The setting method of the magnetic disk apparatus according to claim 1, wherein
the setting the servo data gain includes setting the servo data gain so that a gain converged value of an automatic gain control amplifier circuit to which the amplified servo data is input is near a medium value of gains of the automatic gain control amplifier circuit, and
the setting the user data gain includes setting the user data gain so that a gain converged value of the automatic gain control amplifier circuit to which the amplified user data is input is near a medium value of gains of the automatic gain control amplifier circuit.

3. The setting method of the magnetic disk apparatus according to claim 1, wherein the setting the user data gain includes:
evaluating, based on a Viterbi algorithm or an error rate, the gain converged value of the automatic gain control amplifier circuit to which the amplified user data is input; and
setting the user data gain based on a result of the evaluation.

4. The setting method of the magnetic disk apparatus according to claim 2, further comprising resetting the user data gain when a signal intensity of the user data varies after the setting the user data gain.

5. The setting method of the magnetic disk apparatus according to claim 3, further comprising resetting the user data gain when a signal intensity of the user data varies after the setting the user data gain.

6. A magnetic disk setting apparatus that performs an operational setting of a magnetic disk apparatus comprising:
a preamplifier that amplifies servo data for positioning-use with a servo data gain and amplifies user data stored in a user area available for reading and writing of given data with a user data gain;
a servo data gain setting unit that sets the servo data gain;
a provisional user data gain setting unit that sets a provisional user data gain as the servo data gain;
a core deviation correction unit that finds a core deviation correction value for correcting positional misalignment between a read core and a write core by using the provisional user data gain; and
a user data gain setting unit that sets the user data gain.
